(19) United States
(12) Patent Application Publication
(10) Pub. No.: US 2009/0035034 A1
(43) Pub. Date: Feb. 5, 2009

(54) FIXING DEVICE AND IMAGE FORMING APPARATUS USING THE SAME

(75) Inventor: Hisayoshi Nagase, Tokyo, (JP)

Correspondence Address: CANTOR COLBURN, LLP, 20 Church Street, 22nd Floor, Hartford, CT, 06103, US

(73) Assignee: KONICA MINOLTA BUSINESS TECHNOLOGIES, INC., Tokyo (JP)

(21) Appl. No.: 12/124,800

(22) Filed: May 21, 2008

(30) Foreign Application Priority Data
Jul. 31, 2007 (JP) JP2007-198671

(51) Int. Cl. G03G 15/20

(52) U.S. Cl. 399/329

(57) ABSTRACT

A fixing device, including: a rotatable heating roller including a heating source; and a pressure applying section including an endless fixing belt which is in pressure-contact with the heating roller and rotates with a rotation of the heating roller, wherein the pressure applying section further includes: a pressure applying member positioned to come into contact with an interior surface of the fixing belt and positioned to be inside both edges of the fixing belt to form a nipping portion between the fixing belt and the heating roller, by pressing the fixing belt against the heating roller; and a lubricant supplying member which supplies a lubricant onto the interior surface of the fixing belt, wherein the fixing device further includes a lubricant removing section including a scraping member to come into contact with the edge of the fixing belt to remove the lubricant.

### CROSS REFERENCE TO RELATED APPLICATION

This application is based on Japanese Patent Application No. 2007-198671 filed on Jul. 31, 2007 with the Japanese Patent Office, the entire content of which is hereby incorporated by reference.

### TECHNICAL FIELD

The present invention relates to a fixing device which applies heat and pressure onto a toner image formed on a recording sheet by an image forming section which uses an electro-photographic method, and permanently fixes the toner image on the recording sheet.

### BACKGROUND OF THE INVENTION

In recent years, concerning a fixing device which is incorporated in an electro-photographic image forming apparatuses, such as a copy machine, a printer, a facsimile, and a compound apparatus having the functions as the same, a method operated by a heated roller (which is also called a heat fixing roller method) is used in various apparatuses, such as from a low speed apparatus to high speed apparatus, a monochromatic apparatus, and a color apparatus. In the fixing device operated by the heating roller method, a transfer member carrying an unfixed toner image is nipped to be conveyed by a fixing-nipping portion including a heating roller, maintained at a predetermined temperature, and a pressure applying roller having an elastic outer layer to pressure-contact with the heating roller, so that said transfer member carrying the unfixed toner image can be heated and pressured by the fixing-nipping portion during conveyance.

Recently, colorization and high speed operation are strongly requested in the field. In order to effectively heat the toner image carried on the transfer member, the nipping portion for fixing tends to be enlarged. In this case, in the above fixing device operated by the heating roller method, the diameters of both rollers are enlarged, or the pressure between both rollers are increased so that the surface of a roller is largely distorted, whereby the nipping portion can be increased. However, such designs tend to require a large-sized fixing device, and to rapidly deteriorate the rollers, which results in an insufficient design of the apparatus.

To overcome these problems, in recent years, a fixing device operated by a fixing belt method has recently been used which includes an endless fixing belt driven by rollers, and a pressure applying pad mounted on the interior surface of the endless fixing belt, whereby the pressure applying pad presses the fixing belt against the heating roller. In the fixing device operated by the fixing belt method, the nipping portion can be set over a relatively broad range.

In the fixing device operated by the fixing belt method, since the fixing belt is in pressure-contact with the heating roller by a pressure applying member, if the friction between an interior surface of the fixing belt and the pressure applying member is relatively great, the transfer member tends to be conveyed irregularly, which results in slipped fixing or creased transfer member.

To overcome these problems, Unexamined Japanese Patent Application Publication No. 2003-195,664 discloses a fixing device which includes a heating roller and a fixing belt having a pressure applying member on its interior surface, wherein a lubricant is applied onto said interior surface of the fixing belt by a lubricant supplying section, so that the friction is reduced, and the driving torque is prevented from being increased, which is an object of said Patent Application.

However, use of the fixing device over a long duration causes the applied lubricant to migrate onto the edges of the fixing belt, and said lubricant further moves onto the exterior surface of the fixing belt, where said lubricant then attaches the recording sheet or enters the image forming apparatus. In addition, since the lubricant migrates onto the exterior surface of the fixing belt, the usable lubricant becomes less, whereby the designed low frictional operation, being an original object of said Patent Application, is not attained.

Further, Unexamined Japanese Patent Application Publication No. 2002-357,968 discloses a fixing device including an oil leakage preventing member, which is formed of grooves, provided on the exterior surface of belt guide members to support the edges of the fixing belt, or provided on the interior surface of the fixing belt. Still further, Unexamined Japanese Patent Application Publication No. 2004-191,744 discloses a fixing belt including a repellent finishing section which is provided on the interior surface of the fixing belt to repel the lubricant.

However, the fixing belts taught in Nos. 2002-357,968 and 2004-191,744, are not sufficient as the technology to prevent the oil from migrating onto the edge of the fixing belt.

### SUMMARY OF THE INVENTION

To overcome the above various problems, an object of the present invention is to obtain a fixing device using a fixing belt, wherein the lubricant is applied onto the interior surface of the fixing belt so that the driving torque is reduced, and said lubricant is prevented from migrating onto the exterior surface of the fixing belt.

The object is attained by the inventions described below.

(1) A fixing device, including:

a rotatable heating roller including a heating source; and

a pressure applying section including an endless fixing belt which is in pressure-contact with the heating roller and rotates with a rotation of the heating roller,

wherein the pressure applying section further includes:

a pressure applying member positioned to come into contact with an interior surface of the fixing belt and positioned to be inside both edges of the fixing belt to form a nipping portion between the fixing belt and the heating roller, by pressing the fixing belt against the heating roller; and

a lubricant supplying member which supplies a lubricant onto the interior surface of the fixing belt,

wherein the fixing device further includes a lubricant removing section including a scraping member to come into contact with the edge of the fixing belt to remove the lubricant.

(2) A fixing device, including:

a rotatable heating section including a heating source and an endless fixing belt; and

a pressure applying roller which is in pressure-contact with the heating section and rotates with the heating section,

wherein the heating section further includes:

a pressure applying member which is positioned to come into contact with an interior surface of the fixing belt and positioned to be inside both edges of the fixing belt to form a nipping portion between the fixing belt and the pressure applying roller;

a lubricant supplying member which supplies a lubricant onto the interior surface of the fixing belt;

wherein the fixing device further includes a lubricant removing section including a scraping member to come into contact with the edge of the fixing belt to remove the lubricant.

(3) A fixing device, including:
a rotatable heating section including a heating source and a first endless fixing belt; and

a pressure applying section which is in pressure-contact with the heating section to form a nipping portion, and has a second endless fixing belt to rotate with the heating section,

wherein the heating section further includes;

a first pressure applying member which is positioned to come into contact with an interior surface of the first fixing belt and positioned to be inside both edges of the first fixing belt, to form a nipping portion between the first fixing belt and the pressure applying section, by pressing the first fixing belt against the pressure applying section; and

a first lubricant supplying member which supplies a lubricant onto the interior surface of the first fixing belt,

wherein the pressure applying section further includes

a second pressure applying section which is positioned to come into contact with an interior surface of the second endless fixing belt and positioned to be inside both edges of the second endless fixing belt, to form a nipping portion between the second endless fixing belt and the heating section, by pressing the second endless fixing belt against the heating section; and

a second lubricant supplying member which supplies a lubricant onto the interior surface of the second endless fixing belt,

wherein the fixing device further includes a lubricant removing section which has a scraping member to come into contact with the edge of at least one of the first fixing belt and the second endless fixing belt to remove the lubricant.

### BRIEF DESCRIPTION OF THE DRAWINGS

FIG. 1 is a cross-sectional view of an image forming apparatus relating to the present embodiments.

FIG. 2 is a cross-sectional view of fixing device 8 using a fixing belt.

FIG. 3 is an enlarged cross sectional view of heating roller 81 and fixing belt unit 80, and their related components.

FIG. 4 is a perspective view of fixing device 8.

FIG. 5(a) shows lubricant removing section 88 and its related components viewed as a cross-section of the fixing belt.

FIG. 5(b) is an enlarged view of FIG. 5(a).

FIG. 6 shows the relative positional relationship between lubricant removing section 88 and fixing belt 82.

FIGS. 7(a) and (b) are views to explain fixing device 8 relating to another Embodiment, wherein FIG. 7(a) is its perspective view, and FIG. 7(b) shows lubricant removing section 88 and its related components, viewed as a cross-section of the fixing belt 82 as an enlargement.

FIG. 8 is a schematic sectional view of fixing device 8 relating to yet another Embodiment.

FIG. 9 is a schematic sectional view of fixing device 8 relating to yet another Embodiment.

### DETAILED DESCRIPTION OF THE PREFERRED EMBODIMENT

Embodiments of the present invention will be detailed below, but the present invention is not limited to those Embodiments.

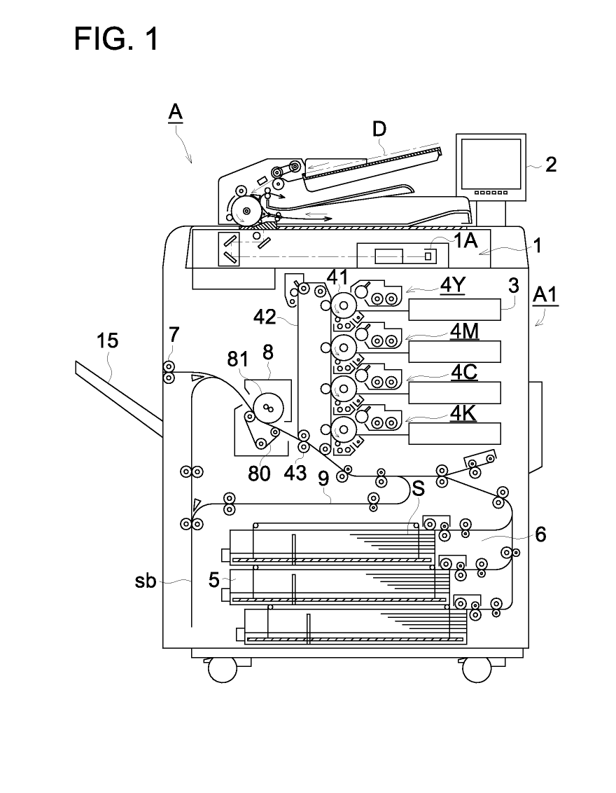

FIG. 1 is a cross-sectional view of image forming apparatus A relating to the present embodiments. Image forming apparatus A is referred to as a tandem type multi-color image forming apparatus, which includes image forming section A1, scanner section 1, operation display section 2, and automatic document feeding device D.

Image forming section A1 includes image creating sections 4Y (which is for the yellow portion of images), 4M (which is for the magenta portion of images), 4C (which is for the cyan portion of images), and 4K (which is for the black portion of images), image writing section 3 (the reference numbers are omitted for M, C and K), intermediate transfer belt 42, sheet supplying cassette 5, sheet supply-conveyance section 6, sheet ejection section 7, fixing device 8, and double surface conveyance route 9. Fixing device 8 will be detailed later.

Each of image creating sections 4 (4Y, 4M, 4C and 4K) has its own developing section, employing a dual component developer including a carrier and one of yellow, magenta, cyan and black toner particles, respectively.

Automatic document feeding section D is mounted on image forming apparatus A. An original document, placed on a platen of automatic document feeding section D, is fed in the arrowed directions, whereby the images, carried on either a single surface or both surfaces, are read by an optical system of scanner section 1, after which the images are sent to CCD image sensor 1A.

After analog signals, photo-electrically converted by CCD image sensor 1A, are processed in a memory control section, with respect to an analog process, an A/D conversion, shading correction, image compression, and the like, processed digital signals are sent to image writing section 3.

In image writing section 3, laser rays, emitted from a semiconductor laser, are radiated onto photoconductor drums 41 (the references numbers for M, C and K are omitted), so that latent images are created. Image creating sections 4 conduct various processes, such as electrical charging, exposure, development, image transfer, sheet separation, drum cleaning, and the like. The respective toner image of each color created by image creating sections 4 is transferred onto rotating intermediate transfer belt 42 by the respective primary transfer section, whereby each color image is superposed on intermediate transfer belt 42 to form a full color image.

The full color toner image on intermediate transfer belt 42 is transferred onto recording sheet S, which is conveyed by sheet supply-conveyance section 6 from sheet supply cassette 5, by paired secondary transfer rollers 43. Recording sheet S, carrying the transferred full color toner image, is heated and pressured by fixing device 8 to become a fixed image, after which recording sheet S is ejected outside the apparatus via sheet ejection section 7, and stored on sheet tray 15.

In the case of double-sided printing, after the image is formed on a first surface (which is the front surface) of recording sheet S, and fixed by fixing device 8, recording sheet S is conveyed to double surfaces conveyance route 9, whereby sheet S is reversed by switch-back route “sb”, and returned to image creating section 4, after which an image is formed on the second surface (which is the reverse surface). Then, recording sheet S, carrying the image on both surfaces, is ejected outside the apparatus via paired sheet ejection rollers 7, and stored on sheet tray 15.

[Fixing Device]

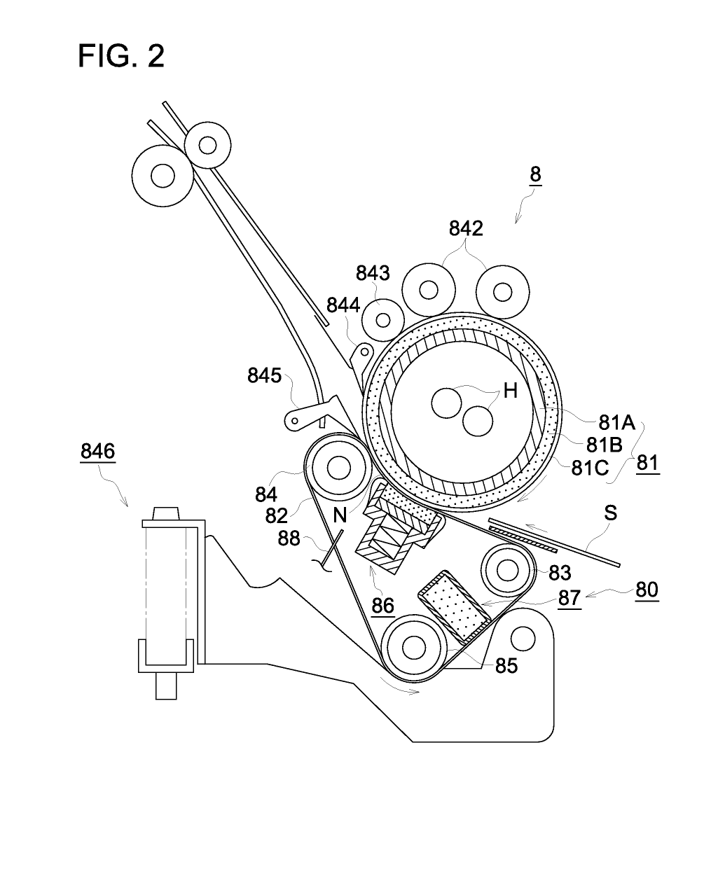

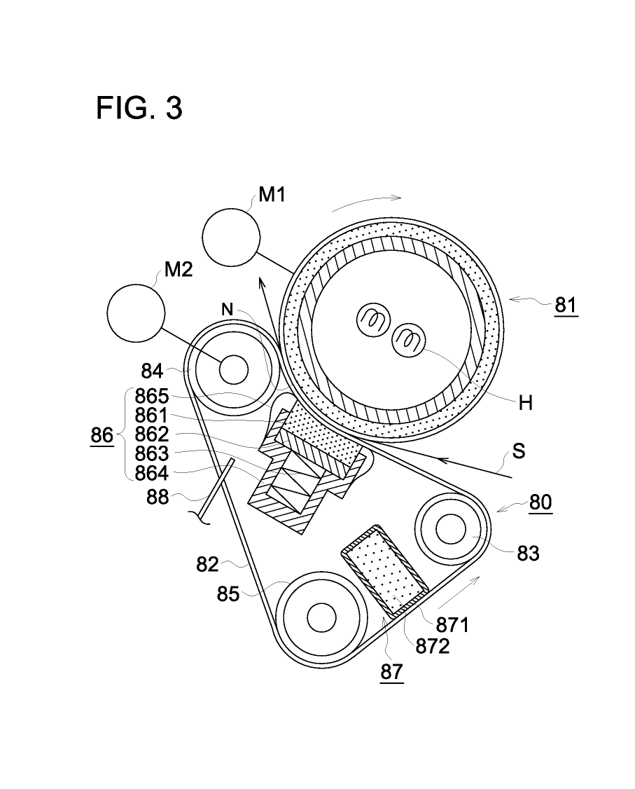

The main structure of fixing device 8, using the fixing belt relating to the present invention, will be detailed below. FIG. 2 is a cross-sectional view of fixing device 8 which employs a fixing belt. FIG. 3 is an enlarged cross sectional view of heating roller 81 serving as a heating section, and fixing belt unit 80 serving as a pressure applying section. Numeral 88 shows a lubricant removing section, which will be detailed later.

In fixing device 8 relating to the present invention, fixing-nip section N, which is formed of heating roller 81 (which is sometimes referred to as a fixing roller) which is heated by a heating source, and fixing belt 82, nips and heats recording sheet S, so that the toner image is permanently fixed on recording sheet S.

Heating roller 81 as shown in FIG. 2, is formed of: cylindrical metal core 81A formed of aluminum or iron, including halogen lamp H as a heating source; elastic layer 81B formed of heatproof silicon rubber to cover cylindrical metal core 81A; and sheet separating layer 81C which is formed of a fluorine resin, such as PFA (perfluoroalkyl vinyl ether), or PTFE (polytetrafluoroethylene), and covers elastic layer 81B.

Exterior heating section 842, cleaning section 843, sheet separating claw 844, and temperature sensor, which is not illustrated, are provided on the exterior surface of heating roller 81.

Endless fixing belt 82 is formed of a polyimide base at a thickness of approximately 100 μm, and a sheet separating layer formed of PFA or PTFE at a thickness of approximately 25 μm to cover the surface of the base.

Fixing belt 82 is entrained about roller 83 adjacent to the entrance area of sheet S, roller 84 adjacent to the exit area of sheet S, and roller 85 to tension the belt, and comes into pressure-contact with the exterior surface of heating roller 81.

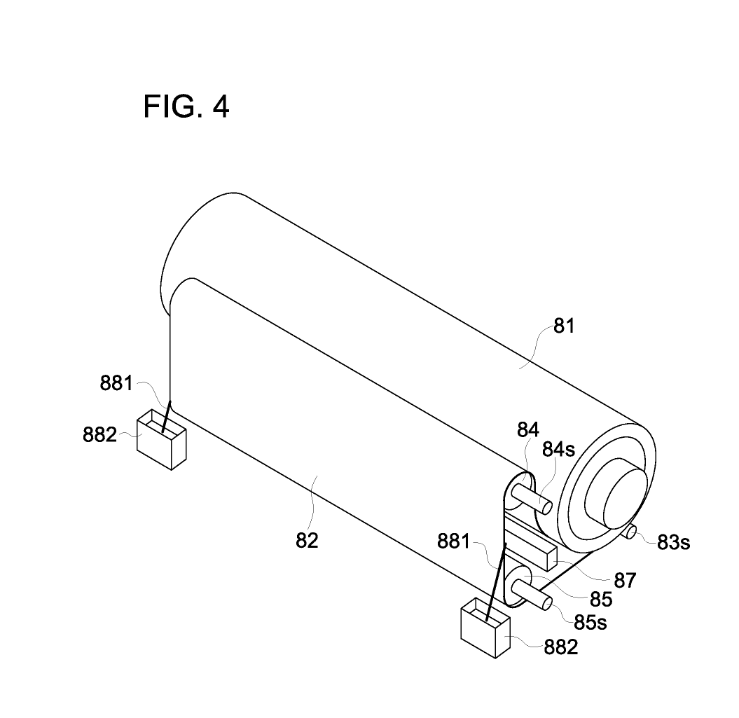

Sheet separating claw 845 comes into contact with the exterior surface of fixing belt 82 entrained about roller 84 being adjacent to the exit area of sheet S, so that separating claw 845 allows sheet S to separate from fixing belt 82. In FIG. 4, roller 85, referred to as a steering roller, includes shaft 85s whose one end is able to be declined so that roller 85 serves as a meandering motion correcting section, whereby unacceptable meandering occurred in a direction across the width of fixing belt 82 is corrected.

Returning to FIG. 2, elevating section 846, being able to vertically move, supports fixing belt unit 80 including fixing belt 82, and rollers 83, 84 and 85, so that elevating section 846 presses fixing belt 82 and pressure applying member 86 against heating roller 81.

Pressure applying member 86 shown in FIG. 3, which presses against fixing belt 82 from its interior, is structured of lubricating sheet 865 which slides against the interior surface of fixing belt 82, pressure applying pad 861, supporting member 862 which supports pressure applying pad 861, compression coil spring 863 which pushes supporting member 862, and holder 864 which accommodates the same. Pressure applying pad 861, positioned between rollers 83 and 84, presses the interior surface of fixing belt 82, so that fixing belt 82 comes into pressure-contact with the exterior surface of heating roller 81. Pressure applying pad 861 is formed of a heat-resistant resin, such as a silicon rubber of JISA hardness 10° which is covered with lubricating sheet 865 formed of PTFE at a thickness of 100-200 μm. Holder 864 is formed of heat-resistant resin.

The edge of the interior surface of fixing belt 82 is covered with fluorine resin layer. To cover the surface with the fluorine resin layer reduces the wetting nature of the lubricant, so that an oil film of the lubricant tends to be rarely created. That is, the moving-through of the lubricant on a lubricant removing member is reduced, so that lubricant leakage is significantly prevented, which will be detailed later.

Upstream of pressure applying member 86, with respect to the rotation direction of fixing belt 82, lubricant supplying member 87 is mounted at the interior area of fixing belt 82. Lubricant supplying member 87 is structured of lubricant coating member 871, lubricant storing section 872, and the like.

Lubricant coating member 871 is formed for example, of non-woven aramid fiber. Foaming materials, such as felt, are enveloped in a sack formed of the non-woven fabric, so that lubricant storing section 872 is formed. The lubricant is previously impregnated into lubricant coating member 871, as well as into lubricant storing section 872. Lubricant storing section 872 stores the lubricant, and supplies it to lubricant coating member 871. As the lubricant, dimethyl silicon oil at a viscosity of 300 cs, or silicon oil, such as methyl phenylsilicon oil at a viscosity of 400 cs, can be used.

On fixing device 8 structured of the various sections described above, heating roller 81 is heated by halogen heater H included therein, and is driven clockwise by motor M1 as shown in FIGS. 2 and 3. Further, pressure applying pad 861 is activated by compression spring 863 through supporting member 862, so that pressure applying pad 861 pushes fixing belt 82 against heating roller 81.

Accordingly, fixing belt 82 is rotated counterclockwise due to the clockwise rotation of heating roller 81 driven by motor M1, which is shown in FIG. 3, whereby fixing belt 82 is elastically curved by the pressure generated between pressure applying pad 861 and heating roller 81. That is, large area fixing-nip section N is formed between fixing belt unit 80 and heating roller 81, so that un-fixed toner carried on conveyed sheet S is heated and fixed at said fixing-nip section N.

Roller 84, positioned at the outlet of the nip is driven by motor M2, and rotates fixing belt 82. Rollers 83 and 85 are in turn driven by the rotation of fixing belt 82.

Positional direction of fixing belt unit 80, which means the positional direction across the width of recording sheet S, which is perpendicular to the sheet conveyance direction, will now be detailed.

When the width of fixing belt 82 is w1, the width of lubricant coating member 871 is w2, the width of pressure applying pad 861 is w3, and the width (being the contact width with fixing belt 82) of rollers 83 and 85 is w4, the following relational expressions are set in the present embodiment.

w1−α>w2,

w1−α>w3,

w1−α>w4,

w2>w3,

where symbol α is a meandering area in the direction across the width of fixing belt 82 [which is a controlled area of a meandering motion control section (being roller 85)].

Due to the above setting relationship, the surfaces on which the various members (being lubricant coating member 871, pressure applying pad 861, and rollers 83-85) contact with fixing belt 82 become narrower than the width of fixing belt 82. Accordingly, any lubricant moved to both end surfaces of the interior surface of fixing belt 82 are not in contact with said various members.

### [Lubricant Removing Member]

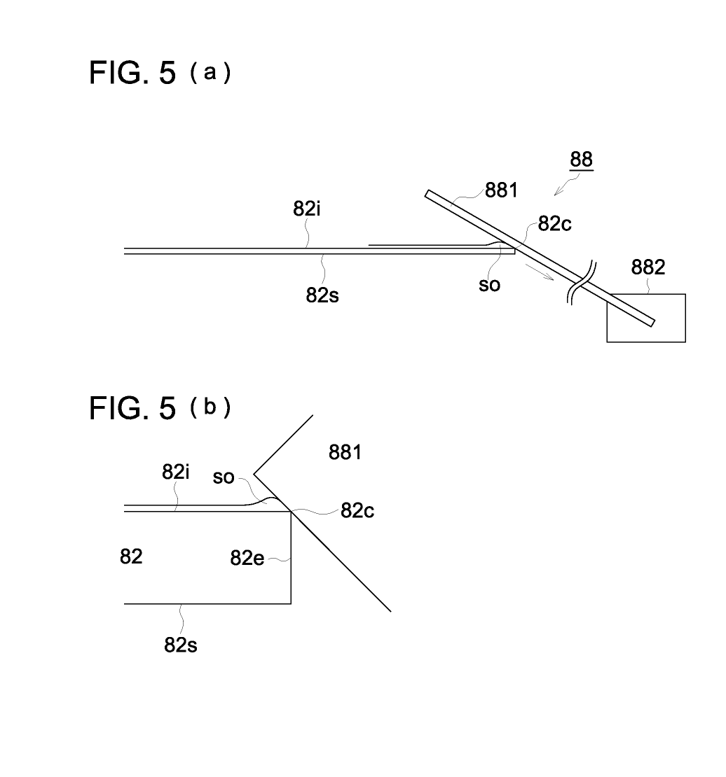

The positional relationship between fixing belt 82 and lubricant removing section 88 will be detailed while referring to FIGS. 4 and 5. FIG. 5(a) shows lubricant removing section 88 and its adjacent area, viewed as a cross-section of the fixing belt. FIG. 5(b) is an enlarged view of FIG. 5(a).

In FIG. 4, lubricant removing sections 88, structured of scraping member 881 and tank 882, are mounted at both edges of fixing belt 82. Lubricant removing sections 88 removes lubricant “so” which are extra ones existing on the edges of fixing belt 82. In FIGS. 5(a) and 5(b), symbol 82s represents an exterior surface of fixing belt 82, symbol 82i represents an interior surface of fixing belt 82, symbol 82e represents an edge of fixing belt 82, and symbol 82c represents an interior surface corner of edge 82e. Lubricant removing section 88 has scraping bar 881 serving as a scraping member which comes into contact with corner 82c of fixing belt 82 and scrapes away extra lubricant “so”, and tank 882, which stores removed extra lubricant “so”. Scraping bar 881 is formed of a round metal bar (being cylindrical), structured of such as stainless steel or copper, or a round resin bar, such as polyimide or polyamide-imide, at a diameter of 0.8 mm-3 mm. A round bar has greater ability to remove extra lubricant “so”, due to its higher viscous attracting capability.

Due to the structure incorporating the lubricant removing section which comes into contact with the interior surface corner of the fixing belt and removes any extra lubricant, a fixing device can be obtained, in which the lubricant is prevented from migrating onto the exterior surface of the fixing belt.

In addition, scraping bar 881 is not limited to the cylindrical round bar, but may be formed of a flexible blade plate as the scraping member. A wide and relatively stiff blade scrapes the interior surface corner of the fixing belt so that the fixing belt is slightly deteriorated, but scraping ability is thereby improved. The flexible blade is formed of a PI sheet at a thickness of 50-200 μm, or a fluorine-coated stainless steel plate at a thickness of 50-100 μm.

Further, if the meandering motion control is conducted by a stationary member, scraping member 881 may also be stationary one, because the fixing belt tends not to vibrate. On the other hand, if the fixing member tends to vibrate due to the meandering motion control, an elastic member, such as a spring, may be mounted at the base of scraping member 881, so that the change of the contact pressure can be controlled due to the elastic force urged to fixing belt 82. Accordingly, elastic deformation at the interior surface corner of fixing belt 82 is reduced, so that stable ability to scrape away the lubricant is durably and stably realized. Still further, in the present embodiment, the meandering motion control section has a probe to contact with the interior surface corner of fixing belt 82, which detects the meandering motion of fixing belt 82. Based on detected signals, shaft 85s of steering roller 85 is declined in the structure of the present embodiment, whereby the meandering motion of fixing belt 82 can be corrected. In this case, one of two scraping members 881 can serve as a probe to contact the interior surface corner of fixing belt 82, as well as a meandering motion controller. This structure will reduce the number of mechanical parts, which results in the reduction of production cost.

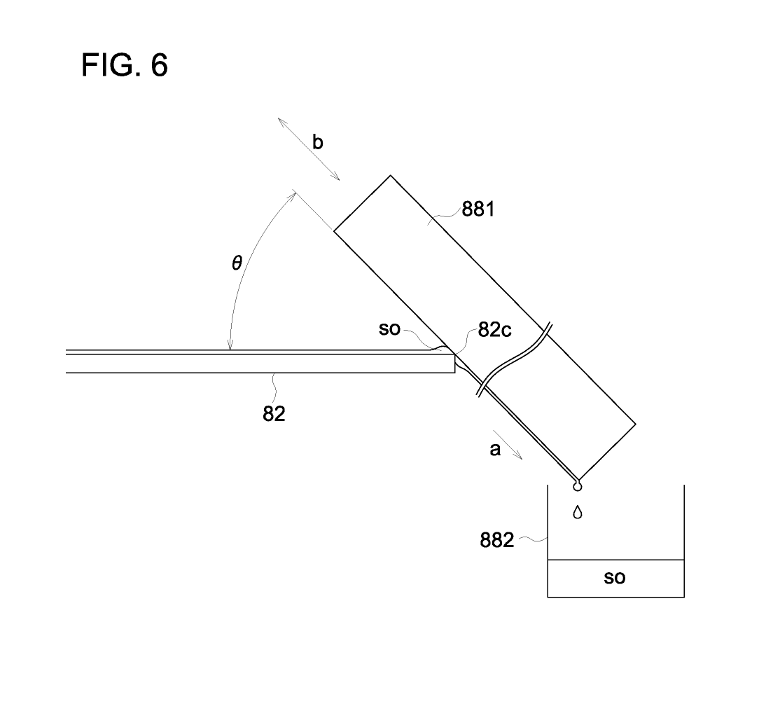

FIG. 6 shows the relative positional relationship between lubricant removing section 88 and fixing belt 82. Scraping member 881 comes into contact with the interior surface corner of fixing belt 82 at angle θ, which is preferably 60°-85° to effectively remove extra lubricant “so” existing on the end portion adjacent to interior surface corner 82c of fixing belt 82. Said extra lubricant “so” is removed by the viscous attracting behavior, and runs down the surface of scraping member 881 by gravity to fall in drops into tank 882.

Further, in FIG. 6, since scraping member 881 has a driving member (which is not illustrated), which is movable in arrowed direction “b”, the contacting points of scraping member 881 and fixing belt 82 can be shifted, whereby abrasion due to constant scraping on a specific point is prevented, and scraping member 881 exhibits a longer functional life.

### Another Embodiment 1

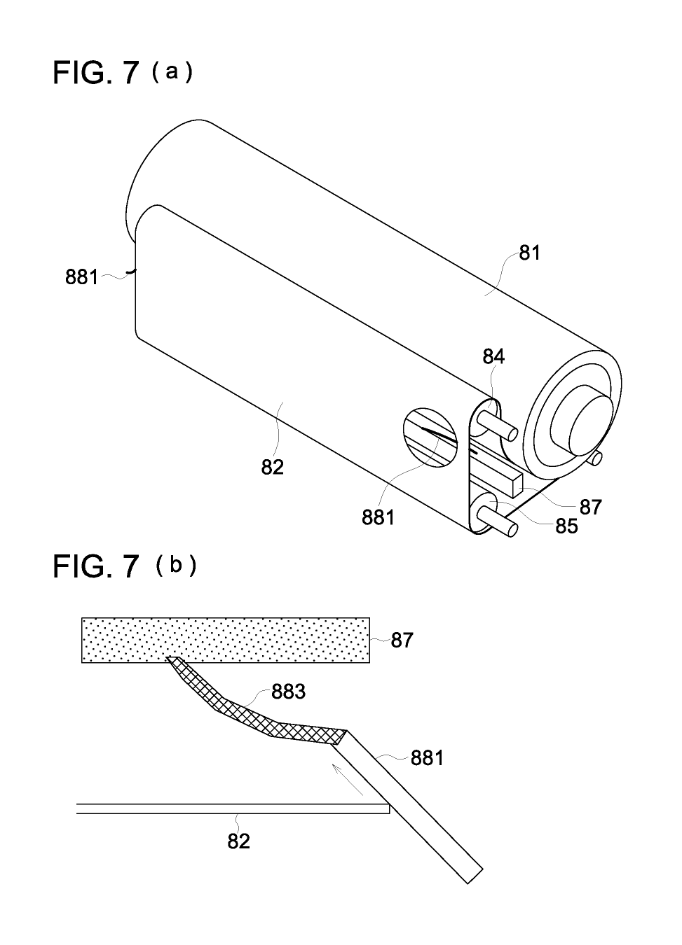

FIGS. 7(a) and 7(b) are views to explain fixing device 8 relating to another Embodiment, wherein FIG. 7(a) is its perspective view, and FIG. 7(b) shows details of lubricant removing section 88 and its adjacent area, viewed as an enlarged cross-section of fixing belt 82. In fixing device 8 shown in FIGS. 7(a) and 7(b), extra lubricant “so”, which was removed by lubricant removing section 88, is recycled to lubricant supplying member 87 so that lubricant “so” is reused. The same numbers are applied to sections in FIGS. 7(a) and 7(b) which serve the same functions as those in FIGS. 2-6, so that the redundant explanations are omitted.

Lubricant removing section 88 in FIG. 7(b) has guide member 883. Scraping member 881 is mounted to incline downward in the gravity direction toward the interior side of fixing belt 82, so that scraped lubricant “so” migrates toward the interior surface of fixing belt 82 along scraping member 881.

Said lubricant “so” is returned to lubricant supplying member 87 serving as a lubricant supplying source, which is mounted farther downstream, through guide member 883 which is connected to a downstream section in the lubricant moving direction, after which lubricant “so” is supplied to the interior surface of fixing belt 82 from lubricant supplying member 87 to be reused again.

Guide member 883 is formed of a porous material, such as an aramid fiber or silicon rubber, so that the lubricant moves easily by capillary action. Such structure is more effective when the height difference between scraping member 881 and lubricant supplying member 87 is relatively small, while when the height difference between scraping member 881 and lubricant supplying member 87 is relatively great, the lubricant tends to move due to gravity so that guide member 883 can be a guide member having a groove to facilitate flow of the lubricant.

The above structure, in which the lubricant scraped away by scraping member 881 is returned to lubricant supplying member 87, makes the lubricant consumption lower, so that an amount of lubricant to be previously impregnated into lubricant supplying member 87 is reduced, or some of the same lubricant can be used for a longer time.

### Another Embodiment 2

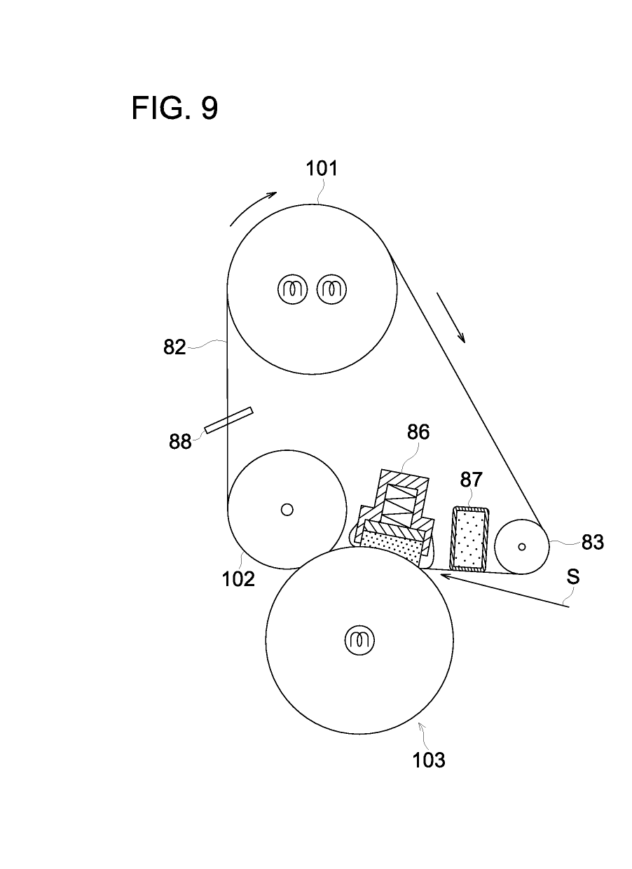

In addition, in the embodiments shown in FIGS. 2-7, the fixing belt is used in the pressure applying section. However, a structure shown in FIG. 9 is also possible to be used for the fixing device, wherein a heating section includes heating roller 101, fixing belt 82, roller 83, pressure applying section 86 to press against the interior surface of fixing belt 82, and upper pressure roller 102, and wherein a pressure applying section includes pressure applying roller 103. Lubricant removing section 88 is mounted to come into contact with the corner of fixing belt 88. Additionally, upper pressure applying roller 102 is not always be used.

### Another Embodiment 3

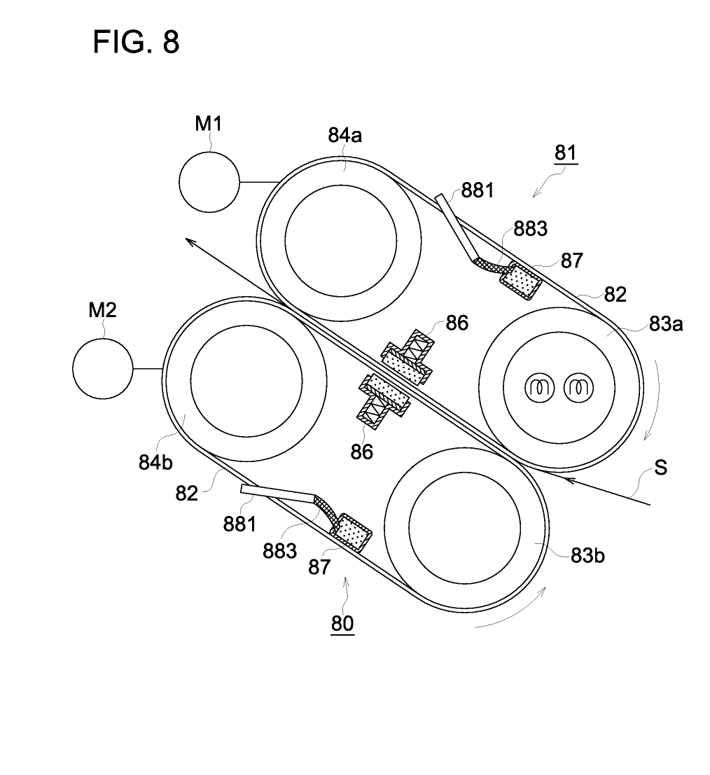

FIG. 8 is a schematic sectional view of fixing device 8 relating to yet another Embodiment. Said fixing device 8 incorporates pressure applying section 80 and heating section 81 including a heating source, both sections 80 and 81 have a separate fixing belt 82. Pressure applying member 86, lubricant supplying member 87, scraping member 881 of lubricant removing section 88, and guide member 883 are mounted around respective fixing belts 81 and 82.

The same numbers are applied to sections in FIG. 8, which have the same functions as those in FIGS. 2-7, so that redundant explanations are omitted.

In the fixing device shown in FIG. 8, lubricant scraping members 881 come into contact with the interior surface corner of fixing belts 82, so that on both fixing belts 82, the lubricant applied onto the interior surface of each fixing belt 82 does not migrate onto the exterior surface of fixing belt 82.

Based on the above embodiments, in the fixing device employing the fixing belt, the lubricant is applied onto the interior surface of the fixing belt, so that the driving torque can be reduced, and said lubricant is prevented from migrating onto the exterior surface of the fixing belt.

What is claimed is:

1. A fixing device, comprising:
a rotatable heating roller including a heating source; and
a pressure applying section including an endless fixing belt which is in pressure-contact with the heating roller and rotates with a rotation of the heating roller,
wherein the pressure applying section further includes:
a pressure applying member positioned to come into contact with an interior surface of the fixing belt and positioned to be inside both edges of the fixing belt to form a nipping portion between the fixing belt and the heating roller, by pressing the fixing belt against the heating roller; and
a lubricant supplying member which supplies a lubricant onto the interior surface of the fixing belt,
wherein the fixing device further includes a lubricant removing section including a scraping member to come into contact with the edge of the fixing belt to remove the lubricant.

2. The fixing device of claim 1, wherein the scraping member comes into contact with an interior surface corner of the edge of the fixing belt.

3. The fixing device of claim 1, wherein the scraping member comprises a round bar.

4. The fixing device of claim 1, wherein the lubricant removing section includes a guide member to return the removed lubricant to the lubricant supplying member serving as a lubricant supplying source.

5. The fixing device of claim 1, wherein the lubricant removing section includes a driving member which shifts a point where the scraping member comes into contact with the fixing belt.

6. An image forming apparatus, comprising:
an image forming section which forms an image on a recording sheet; and
the fixing device of claim 1 which fixes the image formed by the image forming section onto the recording sheet.

7. A fixing device, comprising:
a rotatable heating section including a heating source and an endless fixing belt; and
a pressure applying roller which is in pressure-contact with the heating section and rotates with the heating section,
wherein the heating section further includes:
a pressure applying member which is positioned to come into contact with an interior surface of the fixing belt and positioned to be inside both edges of the fixing belt to form a nipping portion between the fixing belt and the pressure applying roller;
a lubricant supplying member which supplies a lubricant onto the interior surface of the fixing belt;
wherein the fixing device further includes a lubricant removing section including a scraping member to come into contact with the edge of the fixing belt to remove the lubricant.

8. The fixing device of claim 7, wherein the scraping member comes into contact with an interior surface corner of the edge of the fixing belt.

9. The fixing device of claim 7, wherein the scraping member comprises a round bar.

10. The fixing device of claim 7, wherein the lubricant removing section includes a guide member to return the removed lubricant to the lubricant supplying member serving as a lubricant supplying source.

11. The fixing device of claim 7, wherein the lubricant removing section includes a driving member which shifts a point where the scraping member comes into contact with the fixing belt.

12. An image forming apparatus, comprising:
an image forming section which forms an image on a recording sheet; and
the fixing device of claim 7 which fixes the image formed by the image forming section onto the recording sheet.

13. A fixing device, comprising:
a rotatable heating section including a heating source and a first endless fixing belt; and
a pressure applying section which is in pressure-contact with the heating section to form a nipping portion, and has a second endless fixing belt to rotate with the heating section,
wherein the heating section further includes;
a first pressure applying member which is positioned to come into contact with an interior surface of the first fixing belt and positioned to be inside both edges of the first fixing belt, to form a nipping portion between the first fixing belt and the pressure applying section, by pressing the first fixing belt against the pressure applying section; and
a first lubricant supplying member which supplies a lubricant onto the interior surface of the first fixing belt,
wherein the pressure applying section further includes
a second pressure applying section which is positioned to come into contact with an interior surface of the second endless fixing belt and positioned to be inside both edges of the second fixing belt, to form a nipping portion between the second endless fixing belt and the heating section, by pressing the second endless fixing belt against the heating section; and
a second lubricant supplying member which supplies a lubricant onto the interior surface of the second endless fixing belt,
wherein the fixing device further includes a lubricant removing section which has a scraping member to come into contact with the edge of at least one of the first fixing belt and the second endless fixing belt to remove the lubricant.

14. The fixing device of claim 13, wherein the scraping member comes into contact with an interior surface corner of the edge of the fixing belt.

15. The fixing device of claim 13, wherein the scraping member comprises a round bar.

16. The fixing device of claim 13, wherein the lubricant removing section includes a guide member to return the removed lubricant to the lubricant supplying member serving as a lubricant supplying source.

17. The fixing device of claim 13, wherein the lubricant removing section includes a driving member which shifts a point where the scraping member comes into contact with the fixing belt.

18. An image forming apparatus, comprising:
an image forming section which forms an image on a recording sheet; and
the fixing device of claim 13 which fixes the image formed by the image forming section onto the recording sheet.
